(19) United States
(12) Patent Application Publication
(10) Pub. No.: US 2013/0227115 A1
(43) Pub. Date: Aug. 29, 2013

(54) METHOD FOR DETERMINING WHETHER A COMMUNICATIONS SERVICE ROUTE IS OPERATING PURSUANT TO A SERVICE LEVEL AGREEMENT

(71) Applicants: Mark Hobbs, Merritt Island, FL (US); Andrew Stein, Melbourne, FL (US)

(72) Inventors: Mark Hobbs, Merritt Island, FL (US); Andrew Stein, Melbourne, FL (US)

(73) Assignee: Harris Corporation, Melbourne, FL (US)

(21) Appl. No.: 13/407,490

(22) Filed: Feb. 28, 2012

(51) Int. Cl. G06F 15/173

(52) U.S. Cl. 709/224

(57) ABSTRACT

A communications method may be for communications devices configured to define a plurality of communications service routes each subject to a respective service level agreement. The communications devices for each service route may include, in a series coupled arrangement, a customer edge router, a local exchange carrier (LEC) access circuit, an interchange carrier transport circuit, a provider edge router, and an internet protocol computing cloud. The method may include operating a controller coupled to the communications devices to poll each of the communications devices for a device health status. The controller may further be operated to correlate the health statuses to a given communications service route and determine a service state of the given communications service route based upon the health statuses. The controller may further be operated to determine whether the given communications service route is operating pursuant to the service level agreement based upon the service state.

### FIELD OF THE INVENTION

The present invention relates to the field of communications, and, more particularly, to communications service routes and related methods.

### BACKGROUND OF THE INVENTION

A service in the context of Internet Protocol (IP) services in a public multi-protocol layer switching or private network context may be defined as a point to cloud IP connection including a customer edge router, an access circuit from a local exchange carrier (LEC), an interchange carrier transport circuit, a provider edge router, and a backbone provider, which may be in the form of a computing cloud. Each of the above-noted elements may be owned or operated by one or more service providers.

A methodology to define a service, as described above, may be desirable. For example, a customer may desire service performance with respect to service level agreement (SLA) data. The customer may wish to have credits issued to billing based on non-performance of the SLAs.

To address malfunctioning or underperforming services, a system may generate health or system status events that are forwarded to a ticketing system for action, for example, for repair or attention. These events are not correlated to a particular service, inundating the ticketing system and operations personnel with events that are manually correlated to determine actual customer impacts.

Managed and un-managed services with individual SLAs for performance of a customer edge router, LEC access circuit, interchange carrier transport circuit, provider edge router, and backbone or computing cloud, generally do not define the service as including the above-noted components. Instead, one SLA is provided for the entire service or system. Also, some communications service routes' SLAs may not include LEC access circuit performance so while some circuits, for example, the customer edge router, may meet its SLA, the customer may experience reduced overall performance due to relatively poor LEC access circuit performance.

U.S. Pat. No. 5,761,502 to Jacobs is directed to a system for managing a telecommunications network by associating and correlating network events. More particularly, Jacobs discloses performing a sweep of a network object database at regular intervals. This sweep identifies: (1) significant state changes of network element objects corresponding to a network element, such as a switch, customer, country, or service; (2) potentially impacted network elements using predefined relationships among the objects in the network object database; and (3) impacts to the related objects. The impacts to the network elements are reported as a table of correlations.

U.S. Patent Application Publication No. 2008/0304412 to Shine et al. is directed to a system for managing service level agreements associated with a switched metro Ethernet network. More particularly, Shine et al. discloses a service level agreement (SLA) management reporting system (MRS) and a performance engine (PE) data filter coupled to the SLA-MRS. One or more network elements are connected to the PE data filter, and the SLA-MRS is configured to receive performance data from the PE data filter, and at least partially based on the performance data, validate one or more customer claims regarding an SLA violation

It may thus be desirable to determine the performance of a given communication service route. For example, it may be desirable to determine whether a given communication service route is performing subject to its respective SLA.

### SUMMARY OF THE INVENTION

In view of the foregoing background, it is therefore an object of the present invention to determine whether a given communications service route is operating pursuant to a corresponding SLA.

This and other objects, features, and advantages in accordance with the present invention are provided by a communications method for a plurality of communications devices configured to define a plurality of communications service routes each subject to a respective service level agreement. The plurality of communications devices for each service route include, in a series coupled arrangement, a customer edge router, a local exchange carrier (LEC) access circuit, an interchange carrier transport circuit, a provider edge router, and an internet protocol computing cloud. The method includes operating a controller including a processor and a memory coupled thereto, and coupled to the plurality of communications devices to poll each of the plurality of communications devices for a device health status.

The method also includes operating the controller correlate the health statuses to a given communications service route and determine a service state of the given communications service route based upon the health statuses. The method further includes operating the controller to determine whether the given communications service route is operating pursuant to the service level agreement based upon the service state. Accordingly, the communications method may advantageously provide an accounting of operation pursuant to the service level agreement, and adjust billing values for the communications service, for example, when it is not operating pursuant to its corresponding service level agreement

The method may further include operating the controller to filter the device health statuses based upon a threshold number of non-responsive polls. Each device health status may have a priority associated therewith, for example. The method may further include operating the controller to filter the device health statuses based upon the priority.

Each device health status may have a type associated therewith, for example. The method may further include operating the controller to filter the device health statuses based upon exceeding a threshold number for a given type.

The method may further include operating the controller to consolidate the health statuses for the plurality of communications devices, for example. The method may further include operating the controller to calculate billing values based upon whether the given communications service route is operating pursuant to the service level agreement. The method may also further include operating the controller to generate a report for the given communications service route based upon the service state thereof.

The method may also include operating the controller to determine whether the given communications service route is operating pursuant to the service level agreement based upon a change in the service state, for example. The method may further include operating the controller to determine the service state of the given communications service route as one of operational, degraded, in-jeopardy, outage, and maintenance.

### BRIEF DESCRIPTION OF THE DRAWINGS

FIG. 1 is a schematic diagram of a communications system in accordance with the present invention.

FIG. 2 is a flow chart of a communications method according to the present invention.

FIG. 3 is an example health status table used by the controller of FIG. 1.

FIG. 4 is an example service table used by the controller of FIG. 1.

FIG. 5 is an example report generated by the controller of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

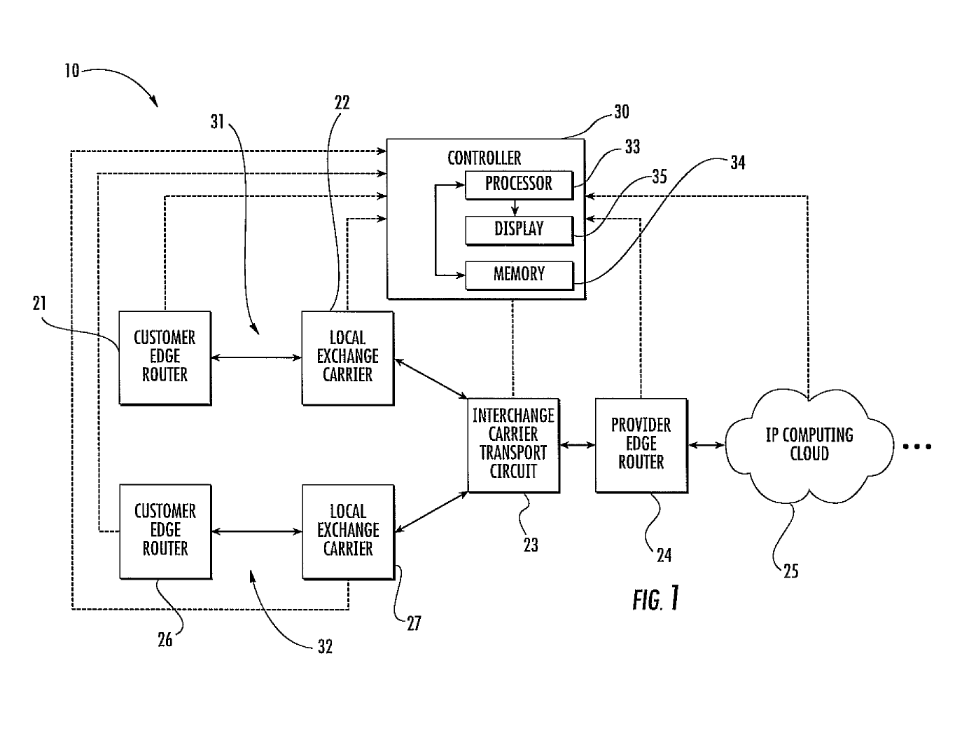

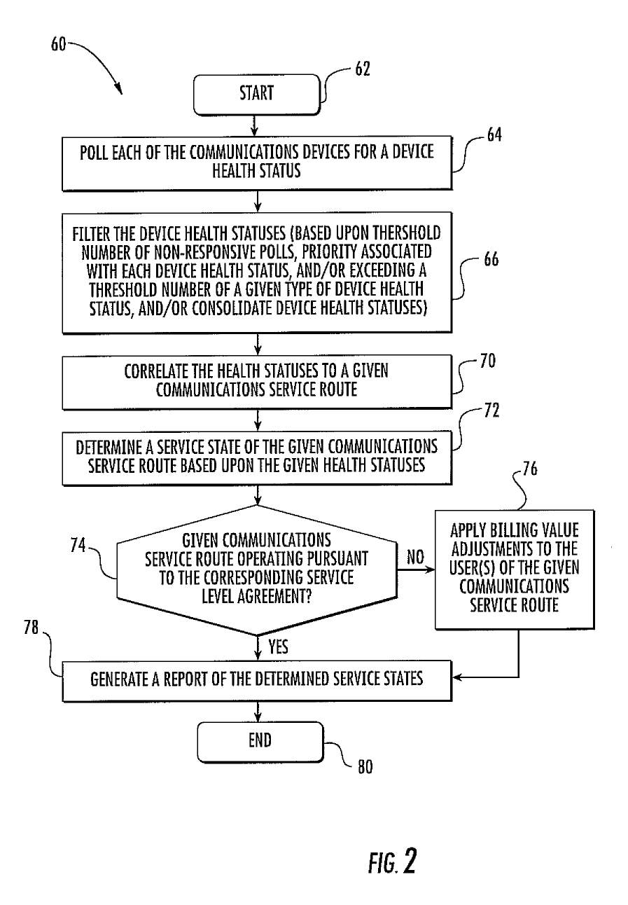

Referring initially to FIG. 1 and the flowchart 60 in FIG. 2, a communications method (Block 62) is described with respect to a communications system 10. The communication system 10 includes communications devices 20 configured to define communications service routes 31, 32. Each of the communications service routes 31, 32 may be designated to a particular service, for example, Internet, telephone, etc. A service level agreement (SLA) is associated with each communication service route, or service. For example, a particular service level agreement may include a desired level of service, for example, a guaranteed uptime and/or guaranteed bandwidth. Additional or other communications routes may be defined.

The communications devices 20, for each service route, include, in a series coupled arrangement, a customer edge router 21, a local exchange carrier (LEC) access circuit 22, an interchange carrier transport circuit 23, a provider edge router 24, and an Internet Protocol (IP) computing cloud 25. The communications devices 20 may be defined by a service, for example, a point-to-cloud IP connection. Illustratively, one communications service route 31, for example, for voice communications, is defined by the customer edge router 21, the local exchange carrier (LEC) access circuit 22, the interchange carrier transport circuit 23, the provider edge router 24, and the Internet Protocol computing cloud 25.

Another service route 32, for example, for Internet communications, is defined by a different customer edge router 26, a different local exchange carrier (LEC) access circuit 27, the interchange carrier transport circuit 23, the provider edge router 24, and the Internet Protocol computing cloud 25. In other words, the interchange carrier transport circuit 23, the provider edge router 24 and the Internet Protocol computing cloud 25 are shared for both the voice communication and internet service routes 31, 32.

The communications system 10 also includes a controller 30 coupled to the communications devices 20. The controller 30 may be in the form of one or more computers each including a respective processor 33 and memory 34 coupled thereto. Of course, the functions of the controller 30 may be wholly performed by a single processor, or may be shared across processors. The controller may also include a display 35 coupled to the processor 33, for example.

The controller 30 is configured to poll each communications device 20 for a device health status (Block 64). In a given polling cycle, the controller 30 polls each of the communications devices 20 at least once for a device health status. As will be appreciated by those skilled in the art, a health status may include operational or healthy, failed or unhealthy, or have a corresponding health scale that may include a health status type, a health status priority, and/or a severity, for example. Of course, the health status may include other attributes.

In some embodiments, the controller 30 is also configured to aggregate and filter the health statuses (Block 66). More particularly, the controller 30 may be configured to reduce false unhealthy health statutes and reduce redundant information. The controller 30 is also configured to correlate the health statuses to a given communications service route (Block 70), as will described in further detail below. Prior to correlating the health status to a given communications service route, the controller 30 may filter the health statuses (Block 66).

The controller 30 may filter the health statuses based upon a number of retries, for example, three. More particularly, a retry is the number of times the controller 30 retries a non-responsive communications device 20 before moving on to the next polling cycle.

The controller 30 may also filter the health statuses by using holds (Block 66). A hold is the number of next consecutive polling cycles for a given communications device to have a failed health status before the controller 30 considers the given communications device to have a failed health status for purposes of correlation. In other words, if a given communications device has a failed and recovered in a short period of time measured in polling cycles, the controller 30 may not consider health status of the given communications device as failed for correlation to a given communications service route.

Still further, the controller 30 may filter the health statuses by using a global event filter (Block 66). More particularly, after a given number of a same type of health status are polled, does the controller 30 consider a particular communications device 20 to have that status for the purposes of correlation. For example, if after ten polls of a given health status type, for example, slow, failed, or maintenance, will the controller 30 consider the communications device 20 to have the given health status type for the purposes of correlation.

The controller 30 may further filter the health statuses based upon a priority of the health statuses (Block 66). For example, a given health status may have priority associated therewith, for example, urgent, needs attention, etc. The controller 30 may filter the health statuses so that, for example, only urgent health statuses are acted upon, or will be correlated, as described below. Other prioritizing techniques, for example, a scale from one-to-ten, ten being the highest priority, may be used, and the controller 30 may filter health statuses less than or equal to seven, for example.

The controller 30 may further filter the health statuses by combining or consolidating multiple health status events (Block 66). For example, a given communications device, for example, a custom edge router, may have a hundred or more downstream devices coupled to it. Thus, if the custom edge router fails, so do the downstream communications devices. By combining multiple health status events, the controller 30 does not provide the hundred or so health statuses of the downstream devices for correlation. In other words, the health statuses for the downstream devices are suppressed to a single health status. Accordingly, the controller 30 may process data more efficiently.

The polling, aggregating, and filtering functions of the controller 30 may be collectively referred to as event correlation. In some embodiments, for example, where the controller 30 includes multiple coupled computers, the controller may generate a data packet including the device health status for which action is sought.

As noted above, the controller 30 is also configured to correlate the health statuses to a given communications service route (Block 70). In some instances, positive health statuses (i.e., healthy device statuses) are not correlated. The controller 30 may correlate the health statuses to the given communications route based upon the received data packet, for example. More particularly, the controller 30 may “listen” for incoming data packets from event correlation, including health statuses, and cooperate with or include an interface for providing operational support, for example, a service ticketing system.

The controller 30 uses the communications service route data to correlate the health statuses to the given communications service route. For example, in the above example, if the provider edge router 24 has a negative health status, the controller 30 correlates this health status to both the communications service routes for voice communications and for Internet communications. If for example, the different local access circuit 27 has a negative health status, the controller 30 correlates this health status to the Internet communications service route.

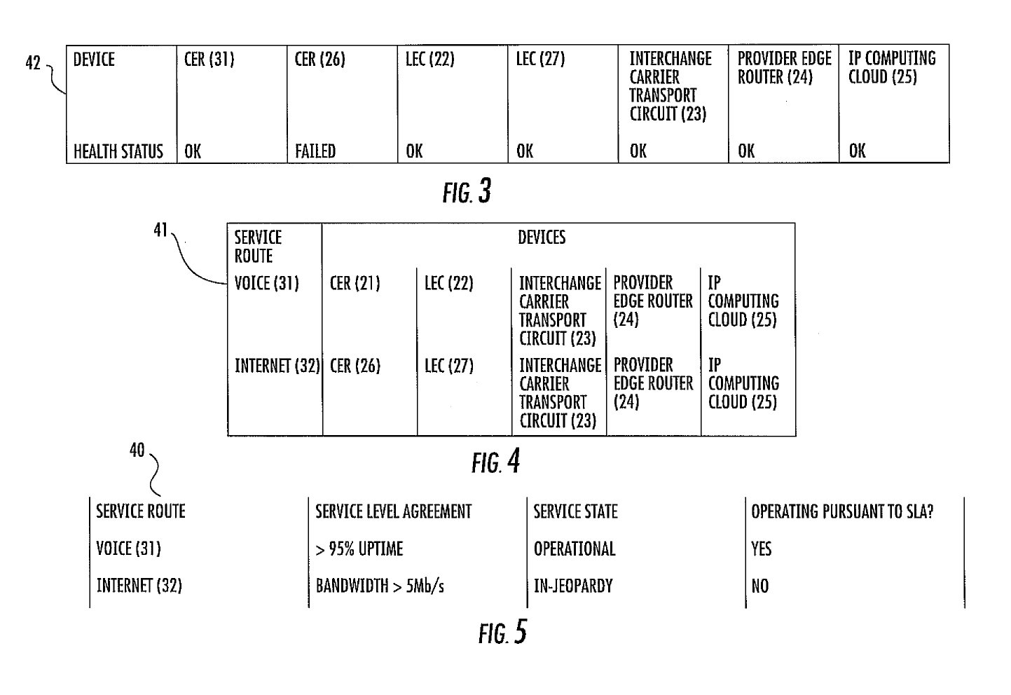

Referring additionally to FIGS. 3 and 4, the controller 30 may correlate the health statuses using a health status table 42 (FIG. 3), and a service-to-device table 41 (FIG. 4). Illustratively, the health status table 42 shows that the different customer edge router 26 has a “failed” health status, while the other devices have an “OK” health status. The “failed” health status of the different customer edge router 26 is correlated to the Internet service route 32 (FIG. 4). Of course, other types of tables may be used by the controller 30, for example, device tables, service tables, and health status tables, or a combination thereof. Other tables, or techniques for correlation may be used, as will be appreciated by those skilled in the art.

The controller 30 is further configured to determine a service state of the given communications service route based upon the health statuses (Block 72). For example, a service state of the given communications service route may be operational, degraded, in-jeopardy (close to failure), in-outage, and down for maintenance. Of course, there may be other or additional service states. As will be appreciated by those skilled in the art, the controller 30 uses the customer edge router state diagram to determine the service state. Changes in services states are recorded by the controller 30, for example, in the memory 34. With respect to the above example wherein the different customer edge router 26 has a “failed” health status, the controller 30 may determine that the associated service route 32, the Internet, may be in-jeopardy, for example.

Referring additionally to FIG. 5, based upon the service state, or change thereof, for example, from operational to in-jeopardy, the controller 30 advantageously determines whether the given communications service route is operating pursuant to the service level agreement (Block 74). For example, if the Internet communications service route 32 is subject to a service level agreement of a threshold bandwidth, the controller 30 advantageously determines whether the threshold bandwidth was maintained pursuant to the service level agreement.

The controller 30 may generate a performance report 40 (Block 78). For example, the controller 30 may generate and send a performance report 40 indicative of whether the communications service routes are operating pursuant to corresponding service level agreements and also indicating the corresponding service state. The performance report 40 illustrates that based upon the failed health status of the different customer edge router 26, the Internet service route 32 is in-jeopardy, and is not performing pursuant to its service level agreement. In contrast, the voice service route 31, all of its devices having an “OK” or healthy health status, is indicated as operational and operating pursuant to its corresponding service level agreement. The controller 30 may display the performance report 40 on the display 35, for example.

Moreover, as will be appreciated by those skilled in the art, service charges by providers may be based upon meeting the requirements set forth in the service level agreements. In some embodiments, if the given service route is not performing pursuant to its corresponding service level agreement (Block 74), for example, as noted above, the Internet service route 32, the controller 30 may determine a percentage of a billing cycle that a given communications service route is not performing pursuant to the service level agreement. The controller 30 may then apply billing value adjustments, for example, credit the appropriate customer account based upon the percentage (Block 76). The method ends at Block 80.

As will be appreciated by those skilled in the art, various functions of the controller 30 may be implemented by using various commercial off the shelf (COTS) products. For example, polling and a portion of the event correlation may be performed by the Orion Network Performance Monitor available from SolarWinds, Inc. of Austin, Tex. Additionally, some of the correlation functions of the controller 30 may be implemented using the Kiwi Syslog Server, also available from SolarWinds, Inc. of Austin, Tex. Other correlation functions and help desk ticketing functions of the controller 30, for example, may be implemented using a customized version of BMC Remedy, available from BMC Software of Houston, Tex.

While the communications devices are coupled to define a particular communications service route, the concepts described herein may be applicable to other types of communications service routes. Many modifications and other embodiments of the invention will also come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communications method for a plurality of communications devices configured to define a plurality of communications service routes each subject to a respective service level agreement, the plurality of communications devices for each service route comprising in a series coupled arrangement, a customer edge router, a local exchange carrier (LEC) access circuit, an interchange carrier transport circuit, a provider edge router, and an internet protocol computing cloud, the method comprising:
operating a controller comprising a processor and a memory coupled thereto, and coupled to the plurality of communications devices to
poll each of the plurality of communications devices for a device health status,
correlate the health statuses to a given communications service route,
determine a service state of the given communications service route based upon the health statuses, and
determine whether the given communications service route is operating pursuant to the service level agreement based upon the service state.

2. The method of claim 1, wherein the controller is further operated to filter the device health statuses based upon a threshold number of non-responsive polls.

3. The method of claim 1, wherein each device health status has a priority associated therewith; and wherein the controller is further operated to filter the device health statuses based upon the priority.

4. The method of claim 1, wherein each device health status has a type associated therewith; and wherein the controller is further operated to filter the device health statuses based upon exceeding a threshold number for a given type.

5. The method of claim 1, wherein the controller is further operated to consolidate the health statuses for the plurality of communications devices.

6. The method of claim 1, wherein the controller is further operated to calculate billing values based upon whether the given communications service route is operating pursuant to the service level agreement.

7. The method of claim 1, wherein the controller is further operated to generate a report for the given communications service route based upon the service state thereof.

8. The method of claim 1, wherein the controller is further operated to determine whether the given communications service route is operating pursuant to the service level agreement based upon a change in the service state.

9. The method of claim 1, wherein the controller is further operated to determine the service state of the given communications service route as one of operational, degraded, in-jeopardy, outage, and maintenance.

10. A communications method for a plurality of communications devices comprising:
defining a plurality of communications service routes each subject to a respective service level agreement, the plurality of communications devices for each service route comprising in a series coupled arrangement, a customer edge router, a local exchange carrier (LEC) access circuit, an interchange carrier transport circuit, a provider edge router, and an internet protocol computing cloud;
polling each of the plurality of communications devices for a device health status;
correlating the health statuses to a given communications service route;
determining a service state of the given communications service route based upon the health statuses; and
determining whether the given communications service route is operating pursuant to the service level agreement based upon the service state.

11. The method of claim 10, further comprising filtering the device health statuses based upon a threshold number of non-responsive polls.

12. The method of claim 10, wherein each device health status has a priority associated therewith; and further comprising filtering the device health statuses based upon the priority.

13. The method of claim 10, wherein each device health status has a type associated therewith; and further comprising filtering the device health statuses based upon exceeding a threshold number for a given type.

14. The method of claim 10, further comprising consolidating the health statuses for the plurality of communications devices.

15. The method of claim 10, further comprising calculating billing values based upon whether the given communications service route is operating pursuant to the service level agreement.

16. The method of claim 10, further comprising generating a report for the given communications service route based upon the service state thereof.

17. A communications method for a plurality of communications devices configured to define a plurality of communications service routes each subject to a respective service level agreement, the plurality of communications devices for each service route comprising in a series coupled arrangement, a customer edge router, a local exchange carrier (LEC) access circuit, an interchange carrier transport circuit, a provider edge router, and an internet protocol computing cloud, the method comprising:
operating a controller comprising a processor and a memory coupled thereto, and coupled to the plurality of communications devices to
poll each of the plurality of communications devices for a device health status,
correlate the health statuses to a given communications service route,
determine a service state of the given communications service route based upon the health statuses,
determine whether the given communications service route is operating pursuant to the service level agreement based upon the service state,
calculate billing values based upon whether the given communications service route is operating pursuant to the service level agreement, and
generate a report for the given communications service route based upon the service state thereof and including the calculated billing values.

18. The method of claim 17, wherein the controller is further operated to filter the device health statuses based upon a threshold number of non-responsive polls.

19. The method of claim 17, wherein each device health status has a priority associated therewith; and wherein the controller is further operated to filter the device health statuses based upon the priority.

20. The method of claim 17, wherein each device health status has a type associated therewith; and wherein the controller is further operated to filter the device health statuses based upon exceeding a threshold number for a given type.

21. The method of claim 17, wherein the controller is further operated to consolidate the health statuses for the plurality of communications devices.
